(19) United States
(12) Patent Application Publication
(10) Pub. No.: US 2002/0095342 A1
(43) Pub. Date: Jul. 18, 2002

(54) Robotic waiter

(76) Inventors: Morris Feldman, Franklin, MA (US); Ross Sanger, West Roxbury, MA (US)

Correspondence Address: FAUSTINO A. LICHAUCO, Fish & Richardson P.C., 225 Franklin Street, Boston, MA, 02110-2804, US

(21) Appl. No.: 09/760,617

(22) Filed: Jan. 16, 2001

(51) Int. Cl. G06F 17/60

(52) U.S. Cl. 705/15; 705/16

(57) ABSTRACT

A system for implementing a robotic waiter includes a menu-translator in communication with the restaurant-POS system for translating a selected menu stored in the restaurant-POS system into a structured menu-document representative of the selected menu, a menu-presentation engine in communication with the menu-translator for translating the structured menu-document into a format understandable by a conventional browser, an order-presentation engine for creating a structured order-document on the basis of data received from the browser, and an order-translator in communication with the restaurant-POS system for translating the structured order-document into a format understandable by the restaurant-POS system.

This invention relates to interfaces between computer systems, and in particular, to a robotic waiter that interfaces between a browser and restaurant POS system.

### BACKGROUND

To orchestrate the preparation of a meal, many modern restaurants have installed specialized point-of-sale (“POS”) systems. When such a system is available, the meal-preparation process begins with entry of a customer's order into a nearby terminal of the POS system. The POS system then decomposes the order into constituent elements and verifies that all the elements are currently available. It then sends messages to the those workers who will be responsible for preparing each of the constituent elements of the meal.

In an effort to expand revenue without having to increase seating, many restaurants have begun accepting take-out orders. The process for preparing a take-out meal typically parallels that of preparing an eat-in meal. The most significant difference, however, is the first step, in which a waiter enters the order into the POS system.

In the case of an eat-in meal, the waiter provides a menu to every customer at a table. The waiter then leaves the table to service other tables. Meanwhile, the customers peruse the menu and decide what to order. After a few minutes, by which time the customers have presumably made up their minds, the waiter returns and polls each customer for their order. The waiter then enters the collected orders for that table into the POS system.

In the case of a take-out meal, the waiter typically communicates with the customer by telephone. In most cases, the customer does not have the benefit of a printed menu. The waiter may therefore have to spend considerable time providing rudimentary information that would otherwise be plainly visible on the menu. In many cases, the customer may have to relay information to his dining companions. The waiter may then have to stay on the telephone while the customer and his dining companions negotiate among themselves about what to order.

It is apparent that the ordering process for a take-out meal is potentially far more time consuming than the ordering process for an eat-in meal. To some extent, the time-consuming nature of a take-out order is alleviated by providing on-line menus at a web site. However, even when an on-line menu is available, the waiter must ultimately take the time to enter the order into the POS system. Because most meals are ordered during a limited window of time, this order entry task often takes place when the waiter is already very busy serving eat-in customers.

### SUMMARY

The invention provides a robotic waiter that takes orders from an off-site customer and enters those orders directly into the restaurant-POS system. As a result, the restaurant avoids consuming limited service resources in taking telephone or web orders and entering them into the restaurant-POS system.

A system for implementing the robotic waiter can include a menu-translator in communication with the restaurant-POS system for translating a selected menu stored in the restaurant-POS system into a structured menu-document representative of the selected menu. The system can also include a menu-presentation engine in communication with the menu-translator for translating the structured menu-document into a format understandable by a conventional browser of the type that an off-site customer would be expected to use. These two components enable an off-site customer to see a web-based version of a menu stored on the restaurant-POS system.

To process incoming orders, the system can also include an order-presentation engine for creating a structured order-document on the basis of data received from the browser. This data is typically representative of a selection of menu-items from the structured menu-document. The system can further include an order-translator in communication with the restaurant-POS system for translating the structured order-document into a format understandable by the restaurant-POS system.

A suitable medium for information exchange between the restaurant-POS system and a conventional browser is an XML document. An XML document enables the representation of data structures such as those present in a menu database within a restaurant-POS system. In addition, an XML document is easily made understandable by a conventional browser. Hence, in one embodiment of the invention, the structured menudocument is an XML document.

An XML document also provides a convenient representation for data representing a selection of one or more menu items. For this reason, in one embodiment of the invention, the structured order-document is an XML document.

In one aspect of the invention, the system also includes a monitor for detecting a change in a menu stored in the restaurant-POS system and alerting the menu translator to the existence of the change. Examples of such changes include: a deletion of a menu-item from the menu; an addition of a menu-item from the menu; a change in a price of a menu-item; and a proposed substitution for a menu item.

In one embodiment of the system, the order translator comprises a keystroke generator that simulates the interaction of a waiter with the restaurant-POS system. The term “keystroke” as used herein includes all gestures performed by a waiter in communicating with the restaurant-POS system. In addition to pressing keys on a keyboard, “keystroke” also includes such gestures as selecting regions from a touch-screen, or using of a mouse or other pointing device.

To better manage the flow of orders arriving from off-site customers, a system for implementing the robotic waiter can include a gateway for regulating communication between the browser and the order-translator. In one embodiment, the gateway includes a rules-engine for rejecting the structured order-document on the basis of one or more specified rules. Examples of a specified rule include: a rule limiting the number of pending orders; a rule limiting the time window during which orders can be accepted, a rule limiting the quantities of items ordered; and a rule limiting the price of an order. The rules engine can be configured to request manual intervention upon detecting a violation of a specified rule, or it can be configured to simply reject an order that does not comply with the rule. Alternatively, the gateway can be configured to request manual intervention upon receipt of a structured order-document.

In another aspect, the invention includes a method of providing a restaurant menu to a browser by specifying a menu stored in a restaurant-POS system, translating the specified menu into a format understandable by the browser, and serving the translated menu to the browser. In one practice of the foregoing method, the translation of the specified menu into a format understandable by the browser is achieved by constructing a structured menu-document representative of the specified menu and translating that structured menu-document into a format understandable by the browser. Because of the ease with which an XML document can be translated into a format understandable by a conventional browser, one practice of the invention includes generating an XML document representative of the specified menu. This XML document can then be translated into an HTML document for service to the browser.

To ensure currency of the menu provided to the off-site customer, the method of providing a restaurant menu optionally includes interrogating the restaurant-POS system to detect a change in the menu stored therein and updating the translated menu in response to a detected change.

The invention also encompasses a method of entering a restaurant order received from a browser into a restaurant-POS system. The foregoing method includes receiving, from a browser, order data representative of a selection of at least one menu item; translating the order data into a format understandable by the restaurant-POS system; and communicating the translated order-data to the restaurant-POS system.

In one practice of the method, translating the order data into a format understandable by the restaurant-POS system comprises translating the data into a structured order-document. Because of the ease with which it can be made understandable to a conventional browser, translating the data into a structured order-document optionally includes generating an XML document representative of the order data.

To avoid overwhelming limited restaurant resources with orders from off-site customers, the method optionally includes regulating the flow of orders from off-site customers. In one practice of the method, the system requests manual intervention following receipt of the order data from an off-site customer. In another aspect of the invention, the order is examined to verify compliance with one or more selected rules. Examples of a rule include a rule limiting the number of pending orders; a rule limiting the time window during which an order from an off-site customer is accepted; a rule limiting the quantities of items ordered; and a rule limiting the price of an order. The method can also provide the added flexibility of requesting manual intervention upon detecting an order that fails to comply with the selected rule. This affords a restauranteur or waiter the opportunity to accept the order notwithstanding one or more rules violated by the order.

Unless otherwise defined, all technical terms used herein have the same meaning as commonly understood by one of ordinary skill in the art to which this invention belongs. Although software and hardware similar or equivalent to those described herein can be used in the practice or testing of the present invention, suitable software and hardware are described below. In case of conflict, the present specification, including definitions, will control. In addition, the hardware, software, and examples are illustrative only and not intended to be limiting.

Other features and advantages of the invention will be apparent from the following detailed description, and from the claims.

### BRIEF DESCRIPTION OF THE FIGURES

FIG. 1 is a diagram of an intermediate computer system interfacing between a restaurant-POS system and a web browser.

FIG. 2 is a diagram of the architecture of a robotic waiter executing on the intermediate computer system of FIG. 1.

FIG. 3 is an illustration of a menu-item as displayed by the web browser of FIG. 1.

FIG. 4 is a listing of a portion of the structured menu-document corresponding to the menu-item of FIG. 3.

FIG. 5 is an illustration of an order for the menu-item of FIG. 3 as displayed by the browser of FIG. 1.

FIG. 6 is a listing of a portion of the structured order-document corresponding to the order shown in FIG. 5.

FIG. 7 is a display of pending orders provided by off-site customers as displayed on the user interface of FIG. 1.

FIG. 8 is an alternative architecture of the robotic waiter of the invention.

### DETAILED DESCRIPTION

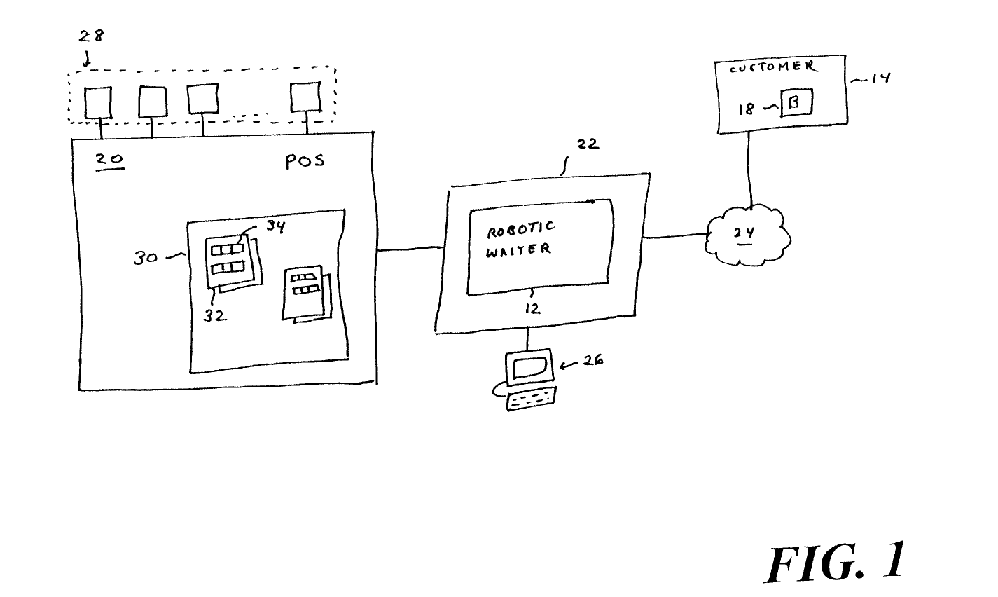

As shown in FIG. 1, a system 10 incorporating the invention provides a robotic waiter 12 with which an off-site customer 14 executing a browser 18 communicates when placing a take-out order. The robotic waiter 12 of the invention communicates directly with a restaurant-POS system 20 in a manner that simulates that in which a live waiter would enter an order into the restaurant-POS system 20.

The robotic waiter 12 is typically implemented on an intermediate computer 22 that communicates with the restaurant-POS system 20 over a local area network. This avoids the imposition of an additional computational burden on the restaurant-POS system 20 and discourages unauthorized access to data stored on the restaurant-POS system 20. However, the subject matter of the invention does not depend on the particular computer that implements the robotic waiter 12. In particular, different processes that constitute the robotic waiter 12 can be implemented on separate computer systems.

In the embodiment shown in FIG. 1, the intermediate computer 22 communicates with an off-site customer 14 over the world-wide web 24. In this case, the intermediate computer 22 acts as a web server. However, in an alternative embodiment, the intermediate computer 22 communicates indirectly with the off-site customer 14 through a web site maintained at a separate facility. Examples of such facilities include a kiosk at a store, in a hotel room, or at an airport or mall. The kiosk might be maintained at the restaurant itself, for example in a waiting arearea. This would enable restaurant patrons to place orders immediately upon arrival. The kiosk may also replace the ordering station at a drive-in restaurant, thereby eliminating the need to begin one's take-out dining experience by shouting an order into a microphone and attempting to decipher the garbled confirmation that follows. Because the location at which a restaurant's web site is maintained is immaterial to the subject matter of the invention, only the first embodiment is described herein.

The intermediate computer 22 also includes a user-interface 26 through which a restauranteur can control its operation. Through this user-interface 26, the restauranteur can accept or reject incoming orders, specify the menus to be presented to the off-site customer 14, and perform routine system maintenance functions. The user-interface 26 can be a terminal connected to the intermediate computer 22 by a cable. Alternatively, the user-interface 26 can be a hand-held portable device that communicates with the intermediate computer 22 on a wireless link.

The restaurant-POS system 20 has several terminals 28 located throughout the restaurant. One or more of these terminals 28 are data-entry terminals that include a monitor and keyboard, or in some cases a monitor and a touch-screen, through which a waiter can enter a customer's order into the restaurant-POS system 20. Other terminals 28 also include printers that print chits containing relevant portions of the order. For example, a terminal 28 located at a drink station includes a printer that prints chits listing only the drinks included in an order so that an attendant can prepare those drinks efficiently, without having to read the entire order. A terminal 28 located at a waiter's station will print a bill, or check, that lists the entire order, complete with prices, so that a customer can scrutinize it before tendering payment.

The restaurant-POS system 20 typically includes a menu database 30 in which are stored several distinct menus 32. These menus 32 are created by the restauranteur for different purposes. For example, there may be a dinner menu, a breakfast menu, a lunch menu, a take-out menu, and a room service menu. Each menu 32 includes one or more menu items 34 represented as records divided into fields. The fields can correspond to data such as: the name of the menu item 34, a description of the menu item 34, a price, a selection of options for accompaniment, and pointers to related menu items 34. The menu database 30 thus embodies considerable structure. Unfortunately, a conventional web browser 18 cannot directly exploit this structure because the menu database 30 is generally in a specialized and proprietary format. In many cases, restaurant POS systems are legacy systems that pre-date the widespread use of browsers.

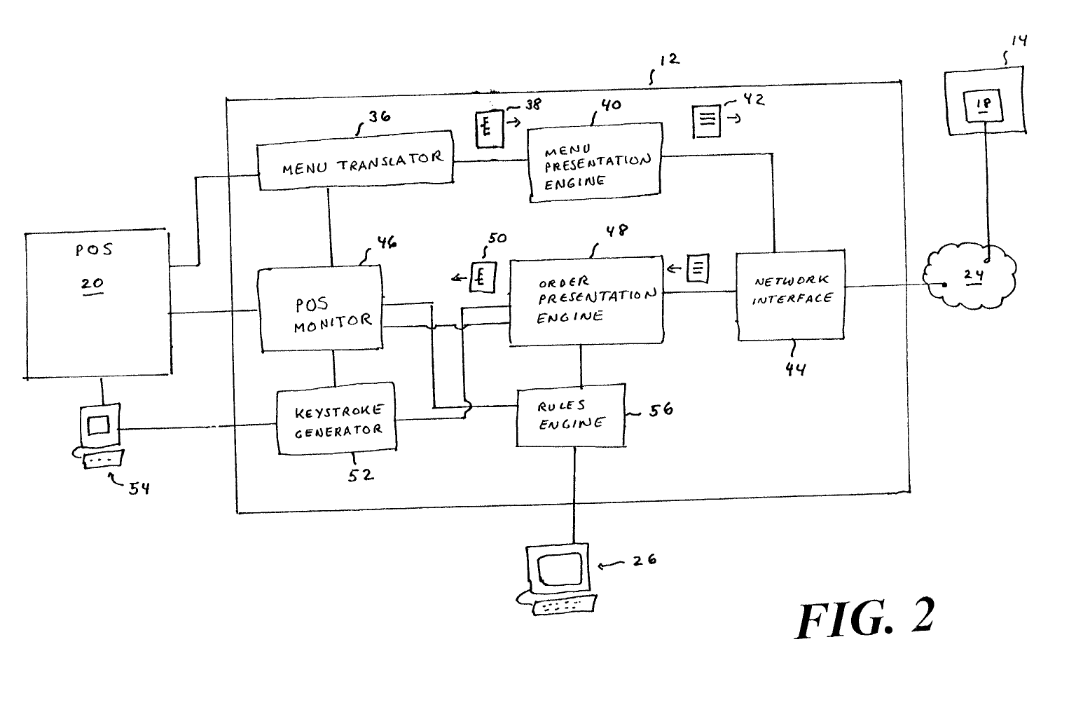

To create an alternate representation of the menu 32 in a form that can be understood by a conventional browser 18, the robotic waiter 12 includes a menu translator 36, shown in FIG. 2, in communication with the restaurant-POS system 20. The menu translator 36 includes software for probing a selected menu 32 on the restaurant-POS system 20 and translating the menu items 34 found in that menu 32 into a structured menu-document 38 that can ultimately be made understandable to a conventional browser 18. The restauranteur specifies the particular menus 32 to be translated by providing menu identifiers to the menu translator 36 through the user-interface 26.

Because the menu database 30 is itself structured, the menu document 38 is also structured. This structure enables one to determine, from examining the structured menu-document 38, which portions of that document correspond to which fields in the original database. A suitable type of structured menu-document 38 for representing a menu database 30 is an XML document. Such a document has the advantage of being easily translatable into an HTML document that can be interpreted by a conventional browser 18.

The menu translator 36 creates an XML representation of relevant portions of the selected menu 32 by recursively probing the menu 32. For a typical tree-structured menu 32, this includes traversing each branch from the root down to each node and copying data from selected fields into an XML document. The data placed into the XML document is tagged to correspond to the field from which it originated. This XML document becomes the structured menu-document 38.

Note that the structured menu-document 38 is not limited to a single web page. Typically, the structured menu-document 38 includes a set of web pages that recreates the entire menu and menu-item sequence, complete with preparation options, modifiers, and accompaniments. In the course of preparing the structured menu-document 38, the menu translator 36 traces out which menu items require additional information from the customer (for example, should a steak be rare or well-done) and what accompaniments (for example rice-pilaf or potatoes) the customer would prefer.

The structured menu-document 38 is then provided to a menu-presentation engine 40 that makes it available to the off-site customer 14. The menu-presentation engine 40 translates the structured menu-document 38 into a servable menu-document 42 that can be understood by a conventional browser 18. This generally requires translation of the structured menu-document 38 into an HTML servable menu-document 42. The menu-presentation engine 40 then posts the servable menu-document 42 to a web site accessible to the off-site customer 14 through a network interface 44.

The web site associated with the restaurant is maintained for public access, either by the restaurant or by an agent operating on behalf of the restaurant. The proximity of the menu-presentation engine 40 to the menu translator 36 in FIG. 2 is not meant to suggest that these two components of the interface necessarily execute on the same machine. For example, if the restaurant web site were maintained by an agent operating on behalf of the restaurant, the menu-presentation engine 40 would likely be remote from the intermediate computer 22. On the other hand, if the restaurant were to maintain its own web site, then the menu-presentation engine 40 would most likely execute on the intermediate computer 22.

In some cases, the network through which the intermediate computer 22 communicates with off-site customers is other than the world-wide web 24. For example, where a restaurant is associated with a hotel, an intranet or virtual private network can be established to enable hotel guests to order from their rooms. Similarly, a restaurant may be on a cruise ship, in which case a shipboard network is used to enable passengers to order meals from their cabins.

The translation of a menu 32 into a corresponding structured menu-document 38 is a time-consuming task. As a result, a structured menu-document 38 is generally not created on demand. Because the structured menu-document 38 is not created on-demand, there exists the possibility that it may not be identical to the menu 32 on the menu database 30 that it purports to represent. For example, a particular menu-item 34 may prove unexpectedly popular, in which case one or more of its constituent ingredients may have been depleted. Or, a restauranteur may want to dispose of an unexpected surplus of one or more ingredients by posting a “daily special” that incorporates those ingredients. In some cases, a price may change. Or, market research may suggest improvements in copy used to describe particular menu items.

To reduce the likelihood of a discrepancy between the structured menu-document 38 and its corresponding menu 32 in the menu database 30 of the restaurant-POS system 20, the robotic waiter 12 optionally includes a POS monitor 46 in communication with the restaurant-POS system 20. The POS monitor 46 periodically “pings,” or interrogates the restaurant-POS system 20 to determine whether any changes have been made to the menu database 30. If the POS monitor 46 detects a change in the menu database 30, it notifies the menu translator 36 of the change. The menu translator 36 can then reconstruct the structured menu-document 38. In one aspect of the invention, the POS monitor 46 identifies the specific changes made to the menu database 30 and communicates those changes to the menu translator 36. This enables the menu translator 36 to update the structured menu-document 38 without having to recreate the entire structured menu-document 38. In another embodiment, the POS monitor 46 only detects the existence of a change but not the substance of that change. In this case, the menu translator 36 recreates the entire structured menu-document 38.

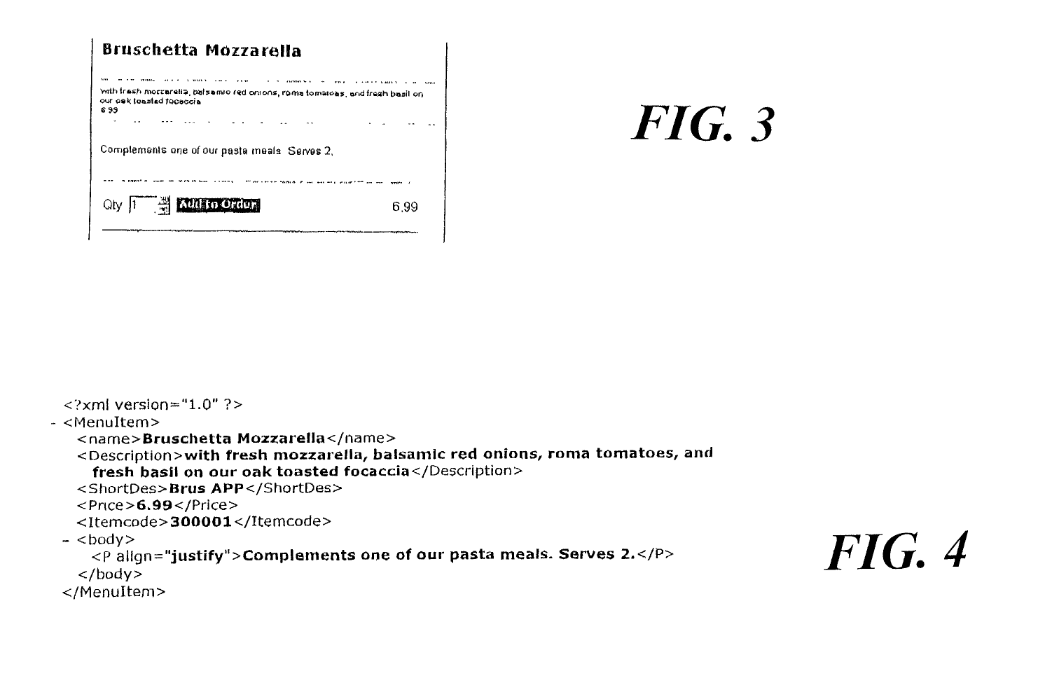

When an off-site customer 14 visits a restaurant web site, the menu-presentation engine 40 serves the servable menu-document 42 to the off-site customer 14. FIG. 3 shows an example of how a browser 18 might interpret a portion of a servable menu-document 42 and display it to an off-site customer 14. The portion of the structured menu-document 38 that creates the display shown in FIG. 3 is listed in FIG. 4. As shown in FIG. 4, the structured menu-document 38 includes information about a selected menu-item 34. Information about this menu item 34 is nested in a “MenuItem” element demarcated by the two tags <MenuItem> and </MenuItem>. Each field from the record corresponding to the selected menu-item 34 is represented as an element surrounded by a pair of tags corresponding to that field. A comparison of FIGS. 3 and 4 shows that some of the elements can remain concealed from the off-site customer 14. For example, neither information contained in the “ItemCode” element nor information contained in the “ShortDes” element are displayed in FIG. 3.

The structured menu-document 38 need not include elements corresponding to each field in a record of the menu database 30. In addition, the structured menu-document 38 can include elements that do not correspond to any field in the menu database 30. For example, the structured menu-document 38 can include auxiliary information such as photographs of the menu item 34, or links to restaurant reviews related to the restaurant generally or to the menu item 34 in particular.

After receiving the servable menu-document 42, the off-site customer 14 prepares an order by selecting one or more menu items from the servable menu-document 42. In some cases, selection of one menu-item will trigger additional displays soliciting customer preferences. For example, in response to selection of filet mignon, the off-site customer 14 may be presented with radio buttons inviting the specification of an extent to which the steak should be cooked. Alternatively, the off-site customer 14 may be presented with check boxes inviting the selection of a suitable accompaniment. Such interactivity can be achieved by embedding functions in the servable menu-document 42 delivered to the off-site customer 14. The embedded functions can also perform such tasks as computing the total cost of the order, including any applicable sales taxes or delivery charges.

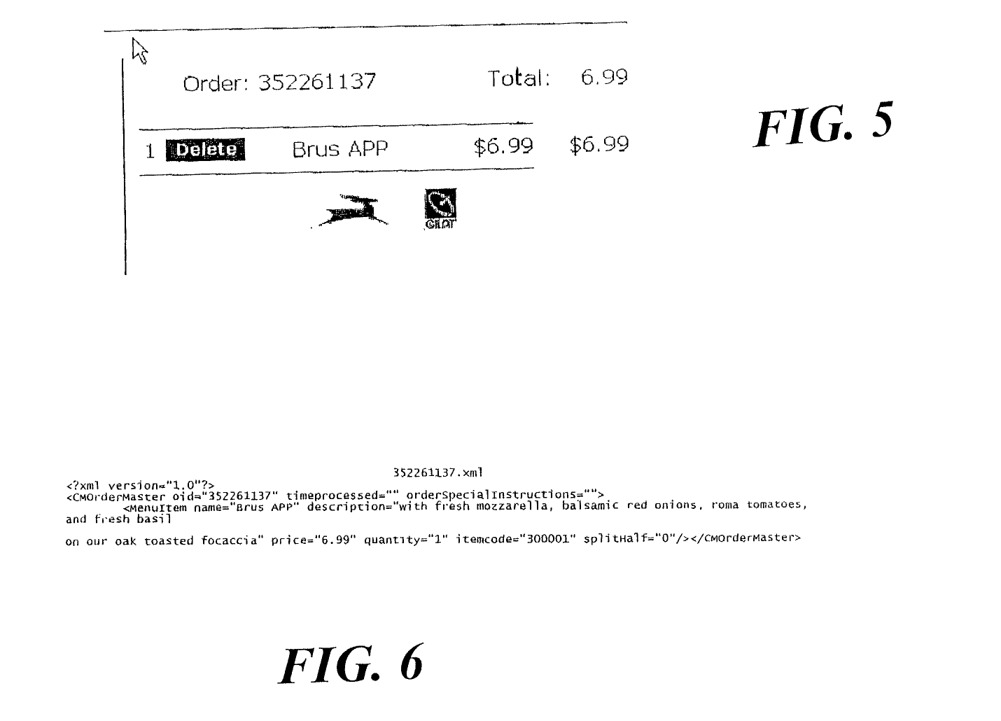

The off-site customer's order, after suitable compression and encryption, is then transmitted to the robotic waiter 12, where it is decompressed, decrypted, and provided to an order-presentation engine 48. The order-presentation engine 48 creates a structured order-document 50 (typically another XML document) containing the parameters of the order. FIG. 5 shows how an order for the menu item 34 shown in FIG. 3 might appear to an off-site customer 14. FIG. 6 shows a portion of a structured order-document 50 corresponding to the display of FIG. 5. The structured order-document 50 includes a root element “CMOrderMaster” with several attributes, only one of which (“oid”) is in use for this example.

The order-presentation engine 48 parses the structured order-document 50 to verify its internal consistency. For example, the order presentation engine 48 can verify that each menu item in the structured order-document 50 includes the correct price and that any accompaniments or preparation instructions are correctly specified. The order-presentation engine 48 then sends a message to the POS monitor 46 to verify availability of all ingredients for all menu items listed in the structured order-document 50. Although the servable menu-document 42 provided by the menu-presentation engine 40 is presumably current, this optional step serves as an additional check on the restaurant's ability to prepare all menu-items listed in the structured order-document 50.

In another optional step, the order-presentation engine 48 sends a message to the POS monitor 46 requesting that the POS monitor 46 provide some measure of how busy the restaurant is. From this measure, the order-presentation engine 48 can estimate the time required to prepare all menu-items listed in the structured order-document 50. Examples of suitable measures for how busy the restaurant is include the number of open checks currently being maintained by the restaurant-POS system 20 or the number of open terminals 54 available.

In some cases, a customer who is in a particular hurry may want to ensure that an order can be filled within a particular interval. A customer who wants a particular seasonal dish may inquire about the availability of that dish without having to take the time to place an order. Under these circumstances, the order-presentation engine 48 can communicate with the POS monitor without generating a structured order-document 50.

Once the order-presentation engine 48 has verified the internal consistency of the structured order-document 50 and confirmed that all necessary ingredients are available, it sends a message back to the off-site customer 14 confirming acceptance of the order. The acceptance can include an estimate of the amount of time required to prepare the order, and hence a proposed time for pick-up or delivery of the order.

In one practice of the invention, the order-presentation engine 48 provides the structured order-document 50 directly to a keystroke generator 52 that functions as an order-translator. The keystroke generator 52 then translates the structured order-document 50 into a sequence of keystroke macros, each one of which corresponds to one menu-item from the structured order-document 50. Each keystroke macro mimics the keystrokes and other gestures that a waiter would otherwise perform in entering the identical order into the restaurant-POS system 20. Alternatively, the keystroke generator 52 directly creates data structures identical to those that would be generated by manually keying in the order and provides those data structures to the restaurant-POS system 20.

The keystroke generator 52 then establishes communication with the restaurantPOS system 20. Typically, the keystroke generator 52 does so by sending a request to the POS monitor 46. The POS monitor 46 then pings the restaurant-POS system 20 to look for an open terminal 54. Once the POS monitor 46 locates an open terminal 54, it sends a message back to the keystroke generator 52, which then seizes control of the open terminal 54 and uses it to transmit, to the restaurant-POS system 20, a stream of keystrokes and gestures corresponding to the menu items listed in the structured order-document 50. In response, the restaurant-POS system 20 performs those functions it would have performed had a live waiter, rather than the keystroke generator 52, entered the same keystrokes and gestures.

A difficulty associated with a direct connection between the keystroke generator 52 and the order presentation engine 48 is the absence of control by the restauranteur. For example, when the restaurant is particularly busy, or expected to be busy, the restauranteur may prefer to limit the volume of take-out orders to assure adequate service for eat-in customers. A direct connection between the keystroke generator 52 and the order presentation engine 48 can result in a flurry of take-out orders that could overwhelm the limited resources of a restaurant.

Another danger associated with a direct connection between the keystroke generator 52 and the order presentation engine 48 is the possibility of error on the customer's part. For example, an off-site customer 14 may inadvertently enter an order in which there are two entrees and twelve desserts. A keystroke generator 52 and order presentation engine 48 operating blindly may not recognize the anomaly in such an order.

To alleviate the difficulties associated with a direct connection to the order presentation engine 48, one embodiment of the invention provides a rules engine 56 that ensures that incoming orders conform to specified rules. Examples of rules that might be implemented by the rules engine 56 include rules specifying time intervals during which no take-out orders are accepted, rules limiting the number of pending take-out orders at any given time, rules limiting the value or volume of any one order, and rules rejecting orders that deviate from the norm in significant ways. These rules can be created and selectively enforced by the restauranteur.

The rules engine 56 examines the structured order-document 50 to determine whether the order it represents complies with all rules currently in force. If the rules engine 56 determines that the order is in compliance, it sends a message back to the order presentation engine 48 authorizing the release of the order to the keystroke generator 52 for fulfillment. If the rules engine 56 determines that the structured order-document 50 manifests a violation of one or more rules implemented by the rules engine 56 it can either summarily reject the order, or bring the order to the personal attention of the restauranteur for disposition. Since the restauranteur may not be monitoring the user-interface 28, this may include paging the restauranteur to draw his attention to a message waiting on the user interface 28.

Whether the rules engine 56 summarily rejects the order or brings it to the restauranteur's attention can be controlled by pre-selecting an attribute for each rule being enforced by the rules engine 56. For example, a restauranteur may want to personally inspect a structured-order document 50 that violates a particular rule but may be willing to summarily reject a structured-order document 50 that violates one of the other rules. In such a case, the restauranteur would, in defining that rule, set an attribute indicating that whenever that rule is violated, the rules engine 56 should notify the restauranteur.

If the restauranteur decides that the order should be rejected, the rules engine 56 sends a message back to the order-presentation engine 48, which then sends a message to the off-site customer 14 detailing the reason for the rejection. If, on the other hand, the restauranteur decides to make an exception, the rules engine 56 sends a message back to the order-presentation engine 48 instructing it to release the structured order-document 50 to the keystroke generator 52.

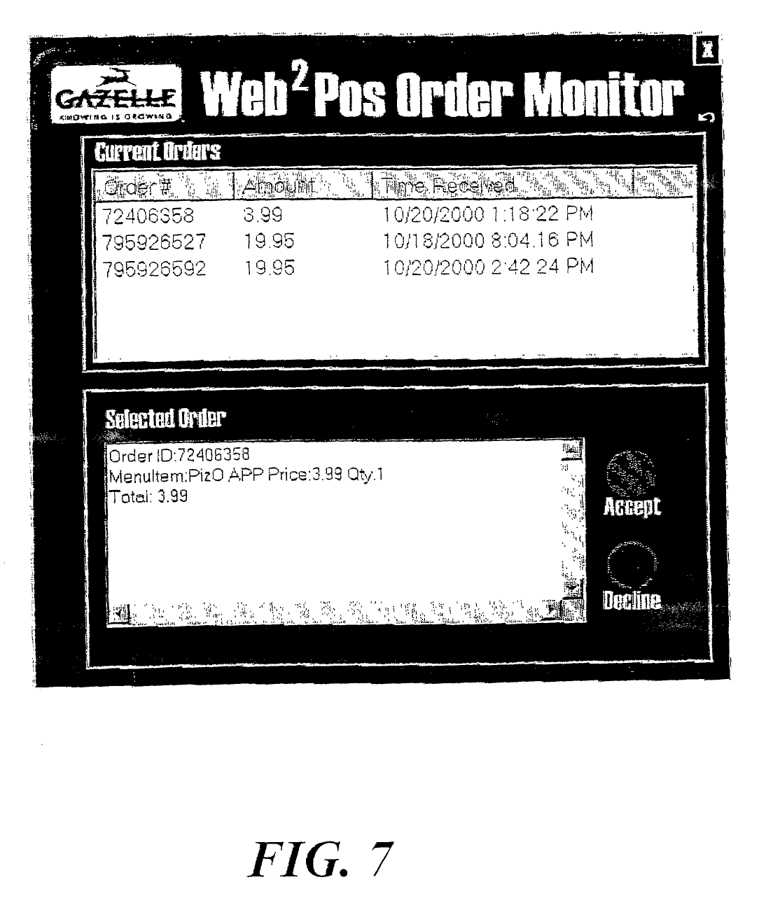

In some cases, a restauranteur may want to personally review all take-out orders. In such a case, the rules engine 56 could be pre-set to display all incoming take-out orders on the user-interface 26. FIG. 7 shows an exemplary display available to the restauranteur at the user-interface 26.

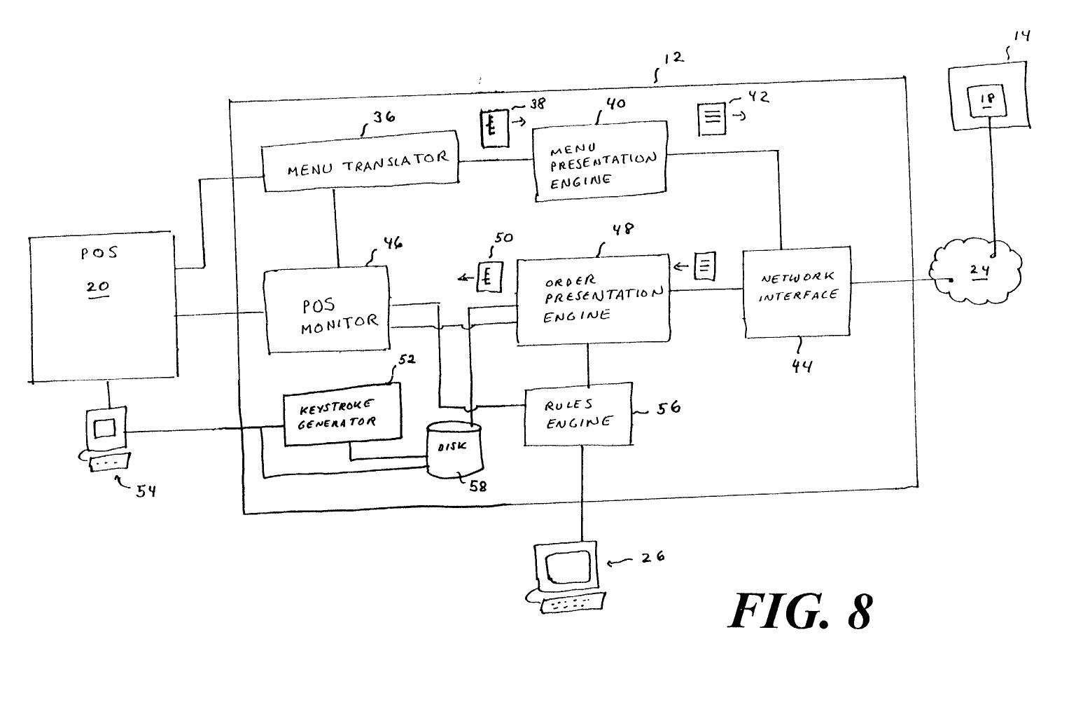

In an alternative embodiment, shown in FIG. 8, the the order presentation engine 48 writes the structured order-document 50 to a designated location on a disk 58. A terminal 54 that is in an idle state is configured to periodically check the designated location on the disk 58 to determine if there are any pending orders. If the terminal 54 determines that there exists a pending order, it instructs the keystroke generator 52 to retrieve the structured order-document 50 and to generate from that document a sequence of keystroke macros, each one of which corresponds to one menu-item from the structured order-document 50. Each keystroke macro mimics the keystrokes and other gestures that a waiter would otherwise perform in entering the identical order into the restaurant-POS system 20.

The robotic waiter 12 of the invention thus enables an off-site customer 14 to place a take-out order with minimal intervention by restaurant personnel. This is achieved by translating a menu stored in the restaurant-POS system 20 into a structured menu-document format that can be converted into a format understandable by a conventional browser 18. The robotic waiter 12 accepts a structured order-document 50 from the off-site customer 14 and translates that structured order-document 50 into a format that can be understood by the restaurant-POS system 20. The interaction between the off-site customer 14 and the restaurant-POS system 20 can optionally be mediated by a gateway that includes a rules engine 56. The rules engine 56 applies selected rules to accept or reject orders and, if necessary, requests manual intervention.

While the particular embodiment described herein makes use of XML documents as a medium of exchange between the robotic waiter and the conventional browser, it is understood that any structured document format that can be understood by a conventional browser can also be used.

The invention can be implemented in hardware or software, or a combination of both. The invention can be implemented in computer programs using standard programming techniques following the method steps and figures described herein. The programs should be designed to execute on programmable computers each comprising a processor, a data storage system (including memory and/or storage elements), at least one input device, and at least one output device, such as a CRT or printer. Program code is applied to input data to perform the functions described herein and generate output information. The output information is applied to one or more output devices such as a CRT, as described herein.

Each program is preferably implemented in a high level procedural or object oriented programming language to communicate with a computer system. However, the programs can be implemented in assembly or machine language, if desired. In any case, the language can be a compiled or interpreted language.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The system can also be considered to be implemented as a computer-readable storage medium, configured with a computer program, where the storage medium so configured causes a computer to operate in a specific and predefined manner to perform the functions described herein.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Having described the invention, and a preferred embodiment thereof,

What we claim as new and secured by Letters Patent is:

1. A system for enabling communication between a browser and a restaurant-POS system, the system comprising:
a menu-translator in communication with the restaurant-POS system for translating a selected menu stored in the restaurant-POS system into a structured menu-document representative of the selected menu;
a menu-presentation engine in communication with the menu-translator for translating the structured menu-document into a format understandable by the browser;
an order-presentation engine for creating a structured order-document on the basis of data received from the browser, the data being representative of a selection of menu-items from the structured menu-document; and
an order-translator in communication with the restaurant-POS system for translating the structured order-document into a format understandable by the restaurant-POS system.

2. The system of claim 1, further comprising a monitor for detecting a change in a menu stored in the restaurant-POS system and alerting the menu-translator to the existence of the change.

3. The system of claim 2, wherein the change is selected from the group consisting of: a deletion of a menu-item from the menu; an addition of a menu-item from the menu; a change in a price of a menu-item; and a proposed substitution for a menu item.

4. The system of claim 1, wherein the order-translator comprises a keystroke generator that simulates the interaction of a waiter with the restaurant POS system.

5. The system of claim 1, wherein the structured menu-document is an XML document.

6. The system of claim 1, wherein the structured order-document is an XML document.

7. The system of claim 1, further comprising a gateway for regulating communication between the browser and the order-translator.

8. The system of claim 7, wherein the gateway comprises a rules-engine for rejecting the structured order-document on the basis of a specified rule.

9. The system of claim 8, wherein the specified rule is selected from the group consisting of: a rule limiting the number of orders; a rule limiting the quantities of items ordered; and a rule limiting the price of an order.

10. The system of claim 8, wherein the rules-engine is configured to request manual intervention upon detecting a violation of a specified rule.

11. The system of claim 7, wherein the gateway is configured to request manual intervention upon receipt of a structured order-document.

12. A method of providing a restaurant menu to a browser, the method comprising:
specifying a menu stored in a restaurant-POS system;
translating the specified menu into a format understandable by the browser; and
serving the translated menu to the browser.

13. The method of claim 12 wherein translating the specified menu into a format understandable by the browser comprises
constructing a structured menu-document representative of the specified menu; and
translating the structured menu-document into a format understandable by the browser.

14. The method of claim 12, further comprising interrogating the restaurant-POS system to detect a change in the menu stored therein.

15. The method of claim 14, further comprising updating the translated menu in response to a detected change.

16. The method of claim 13, wherein constructing a structured menu-document comprises constructing an XML document.

17. The method of claim 16, wherein translating the structured menu-document comprises generating an HTML document representative of the structured menu-document.

18. A method of entering a restaurant order received from a browser into a restaurant-POS system, the method comprising:
receiving, from a browser, order data representative of a selection of at least one menu item; and
translating the order data into a format understandable by the restaurant-POS system; and
communicating the translated order-data to the restaurant-POS system.

19. The method of claim 18, wherein translating the order data into a format understandable by the restaurant-POS system comprises translating the data into a structured order-document.

20. The method of claim 19, wherein translating the data into a structured order-document comprises generating an XML document representative of the order data.

21. The method of claim 18, wherein communicating the translated order data to the restaurant-POS system comprises simulating the interaction of a waiter with the restaurant-POS system.

22. The method of claim 18, further comprising requesting manual intervention following receipt of the order data.

23. The method of claim 18, further comprising examining the order to verify compliance with a selected rule.

24. The method of claim 23, further comprising selecting the selected rule from the group consisting of: a rule limiting the number of orders; a rule limiting the quantities of items ordered; and a rule limiting the price of an order.

25. The method of claim 23, further comprising requesting manual intervention upon detecting an order that fails to comply with the selected rule.

25. The method of claim 18, further comprising accepting the order on the basis of the time at which the order is received.

26. The method of claim 18, further comprising accepting the order on the basis of a current volume of orders in the restaurant-POS system.

27. A computer-readable medium having encoded thereon software for providing a restaurant menu to a browser, the software comprising instructions for:
specifying a menu stored in a restaurant-POS system;
translating the specified menu into a format understandable by the browser; and
serving the translated menu to the browser.

28. The computer-readable medium of claim 27, wherein the instructions for translating the specified menu into a format understandable by the browser comprise instructions for:
constructing a structured menu-document representative of the specified menu; and
translating the structured menu-document into a format understandable by the browser.

29. The computer-readable medium of claim 27, wherein the software further comprises instructions for interrogating the restaurant-POS system to detect a change in the menu stored therein.

30. The computer-readable medium of claim 29, wherein the software further comprises instructions for updating the translated menu in response to a detected change.

31. The computer-readable medium of claim 28, wherein the instructions for constructing a structured menu-document comprise instructions for constructing an XML document.

32. The computer-readable medium of claim 31, wherein the instructions for translating the structured menu-document comprise instructions for generating an HTML document representative of the structured menu-document.

33. A computer-readable medium having encoded thereon software for entering a restaurant order received from a browser into a restaurant-POS system, the software comprising instructions for:
receiving, from a browser, order data representative of a selection of at least one menu item; and
translating the order data into a format understandable by the restaurant-POS system; and
communicating the translated order-data to the restaurant-POS system.

34. The computer-readable medium of claim 33, wherein the instructions for translating the order data into a format understandable by the restaurant-POS system comprise instructions for translating the data into a structured order-document.

35. The computer-readable medium of claim 34, wherein the instructions for translating the data into a structured order-document comprise instructions for generating an XML document representative of the order data.

36. The computer-readable medium of claim 33, wherein the instructions for communicating the translated order data to the restaurant-POS system comprise instructions for simulating the interaction of a waiter with the restaurant-POS system.

37. The computer-readable medium of claim 33, wherein the software further comprises instructions for requesting manual intervention following receipt of the order data.

38. The computer-readable medium of claim 33, wherein the software further comprises instructions for examining the order to verify compliance with a selected rule.

39. The computer-readable medium of claim 38, wherein the software further comprises instructions for selecting the selected rule from the group consisting of: a rule limiting the number of orders; a rule limiting the quantities of items ordered; and a rule limiting the price of an order.

40. The computer-readable medium of claim 38, wherein the software further comprises instructions for requesting manual intervention upon detecting an order that fails to comply with the selected rule.

41. The computer-readable medium of claim 33, wherein the software further comprises instructions for accepting the order on the basis of the time at which the order is received.

42. The computer-readable medium of claim 33, wherein the software further comprises instructions for accepting the order on the basis of a current volume of orders in the restaurant-POS system.
